(19) United States
(12) Patent Application Publication
(10) Pub. No.: US 2019/0295576 A1
(43) Pub. Date: Sep. 26, 2019

(54) DISK DEVICE AND METHOD OF ASSEMBLING THE SAME

(71) Applicants: Kabushiki Kaisha Toshiba, Tokyo (JP); Toshiba Electronic Devices & Storage Corporation, Tokyo (JP)

(72) Inventor: Hiroshi Nagata, Kawasaki Kanagawa (JP)

(21) Appl. No.: 16/129,036

(22) Filed: Sep. 12, 2018

(30) Foreign Application Priority Data
Mar. 22, 2018 (JP) 2018-054694

(51) Int. Cl. G11B 5/48

(52) U.S. Cl. CPC G11B 5/4813; G11B 5/4826; G11B 5/4833

(57) ABSTRACT

According to one embodiment, a disk device includes a rotatable disk-shaped recording medium, a plurality of magnetic heads which process data with respect to the recording medium, a rotatable actuator assembly including a plurality of suspension assemblies which support the plurality of magnetic heads, respectively, and a ramp including a plurality of guide portions engageable with the plurality of suspension assemblies, respectively, and a positioning portion which is configured to position the plurality of suspension assemblies with respect to the ramp during assembly.

### CROSS-REFERENCE TO RELATED APPLICATIONS

This application is based upon and claims the benefit of priority from Japanese Patent Application No. 2018-054694, filed Mar. 22, 2018, the entire contents of which are incorporated herein by reference.

### FIELD

Embodiments described herein relate generally to a disk device and a method of assembling the disk device.

### BACKGROUND

As a disk device, for example, a hard disk drive (HDD) comprises a plurality of magnetic disks provided rotatable in a housing, a plurality of magnetic heads each of which reads or write data from or to a respective magnetic disk and a head actuator which supports the magnetic heads movable with respect to the respective magnetic disks.

The head actuator includes an actuator block rotatably supported and a plurality of suspension assemblies each extending from the actuator block and supporting a magnetic head at a distal end thereof.

The disk device comprises a ramp load mechanism configured to hold the magnetic heads in an unloading position spaced from the respective magnetic disk when the magnetic heads move to the outermost circumference of the magnetic disks. Usually, the ramp load mechanism includes a ramp provided in the housing and a tab provided at the distal end of the respective suspension assembly. When the tab rides on a corresponding step of the ramp, the magnetic head is held at the unloading position.

In recent years, with increase of the storage capacity of disk devices, the number of magnetic disks to be mounted tends to increase. As the number of magnetic disks is increasing, the number of magnetic heads and that of suspensions are also increasing. During the assembly of disk devices, a large number of magnetic heads and suspensions need to be positioned with the respective ramps. But in some cases, due to the repulsive force of the suspensions, the positions of a magnetic head and a respective ramp are displaced with relative to each other, possibly causing a head insertion error, deformation of parts, etc. In this case, the assembly needs to be redone, or damaged parts need to be replaced, which may result in the increase in the manufacturing cost.

### BRIEF DESCRIPTION OF THE DRAWINGS

FIG. 1 is a perspective view showing a hard disk drive (HDD) according to a first embodiment, without a top cover.

FIG. 2 is a perspective view showing an actuator assembly of the HDD.

FIG. 3 is a perspective view showing the actuator assembly, a ramp, and a holder fixture.

FIG. 4 is a perspective view showing the holder fixture.

FIG. 5 is a perspective view showing the actuator assembly equipped with the holder fixture.

FIG. 6 is a perspective view showing the positioning portion of the holder fixture and the ramp.

FIG. 7 is a perspective view showing the positioning portion of the holder fixture and the ramp while engaged with each other.

FIG. 8 is another perspective view showing the positioning portion of the holder fixture and the ramp while engaged with each other.

FIG. 9 is a plan view of the disk device in a state where the actuator assembly is positioned with respect to the ramp during the assembly.

FIG. 10 is a plan view of the disk device in a state where the actuator assembly is engaged with the ramp during the assembly.

FIG. 11 is a perspective view showing a holder fixture used for assembly of an HDD according to a second embodiment.

FIG. 12 is perspective view showing a ramp and the holder fixture of the HDD according to the second embodiment.

FIG. 13 is a perspective view showing the ramp and the holder fixture in a state where the positioning portion of the ramp and the positioning portion of the holder fixture are engaged with each other.

FIG. 14 is a side view showing a rear surface of a ramp and a distal portion of a holder fixture used for assembly of an HDD according to a third embodiment.

FIG. 15 is a perspective view showing the state where positioning engaging portions of the ramp and the holder fixture according to the third embodiment.

FIG. 16 is a side view showing a rear surface of a ramp and a distal portion of a holder fixture used for assembly of an HDD according to a fourth embodiment.

FIG. 17 is a perspective view showing the state where positioning engaging portions of the ramp and the holder fixture according to the fourth embodiment.

### DETAILED DESCRIPTION

Various embodiments will be described hereinafter with reference to the accompanying drawings. In general, according to one embodiment, a disk device comprises a rotatable disk-shaped recording medium; a plurality of magnetic heads which process data with respect to the recording medium; a rotatable actuator assembly comprising a plurality of suspension assemblies which support the plurality of magnetic heads, respectively; and a ramp comprising a plurality of guide portions engageable with the plurality of suspension assemblies, respectively, and a positioning portion which is configured to position the plurality of suspension assemblies with respect to the ramp during assembly.

What is disclosed in this specification is merely an example. Appropriate modifications which can be easily conceived by a person ordinarily skilled in the art without departing from the spirit of the embodiments naturally fall within the scope of the present invention. To further clarify explanation, for example, the width, thickness or shape of each structure may be schematically shown in the drawings compared with the actual forms. Note that the drawings are merely examples and do not limit the interpretation of the present invention. In the specification and drawings, elements which are identical to those of the already-mentioned figures are denoted by the same reference numbers. Thus, the detailed explanation of such elements may be omitted.

### First Embodiment

As a disk device, a hard disk drive (HDD) according to a first embodiment will be described in detail.

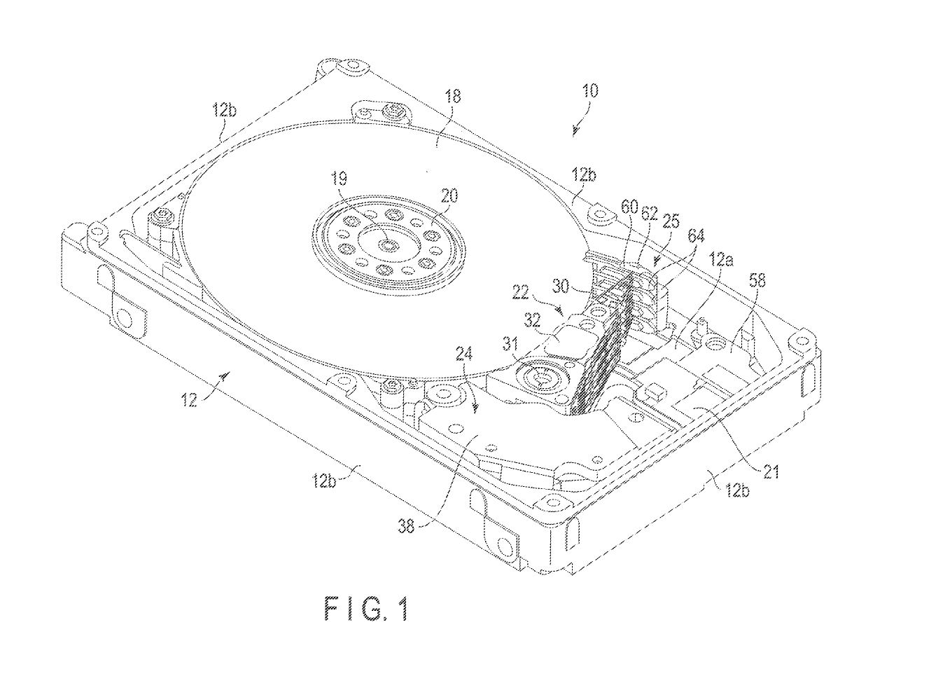

FIG. 1 is an exploded perspective view of the HDD according to the first embodiment illustrated with its top cover detached.

The HDD comprises a flat, substantially rectangular housing 10. The housing 10 comprises a rectangular box-shaped base 12 with an opened upper surface and a top cover (not shown). The base 12 includes a rectangular bottom wall 12a and a plurality of side walls 12b standing along a circumference of the bottom wall 12a, and is integrally formed of aluminum, for example. The top cover 14 is formed in a rectangular plate shape from stainless steel, for example. The top cover 14 is fastened onto the side walls 12b of the base 12 by a plurality of screws 13.

A plurality of magnetic disks 18 as recording media and a spindle motor 19 configured to support and rotate the magnetic disks 18 are provided within the housing 10. The spindle motor 19 is mounted on the bottom wall 12a. Each of the magnetic disks 18 is, for example, 88.9 mm (3.5 inches) in diameter, and includes a magnetic recording layer on its upper and/or lower surfaces. Each of the magnetic disks 18 is coaxially fitted to a hub (not shown) of the spindle motor 19 and is clamped by a cramp spring 20. Each of the magnetic disks 18 is supported in a state of being arranged parallel to the bottom wall 12a of the base 12. The plurality of magnetic disks 18 are rotated at a predetermined revolution by the spindle motor 19.

In this embodiment, for example, four magnetic disks 18 are accommodated in the housing 10, but, the number of the magnetic disks 18 is not limited to this.

Within the housing 10, are provided a plurality of magnetic heads 17 configured to perform writing and reading information on the magnetic disks 18 and an actuator assembly 22 supporting these magnetic heads 17 to be movable relative to the magnetic disks 18. Further, within the housing 10, are provided a voice coil motor (VCM) 24 configured to rotate and position the actuator assembly 22, a ramp load mechanism 25 configured to hold the magnetic heads 17 at an unloaded position separated away from the magnetic disks 18 when the magnetic heads 17 move to an outermost circumference of the magnetic disks 18, and a substrate unit (FPC unit) 21 in which electronic components such as converting connectors and the like.

A printed circuit board (not shown) is fixed to an outer surface of the bottom wall 12a of the base 12 by a screw. The printed circuit board constitutes a control unit configured to control operations of the spindle motor 19 and also operations of the VCM 24 and the magnetic heads 17 via the substrate unit 21.

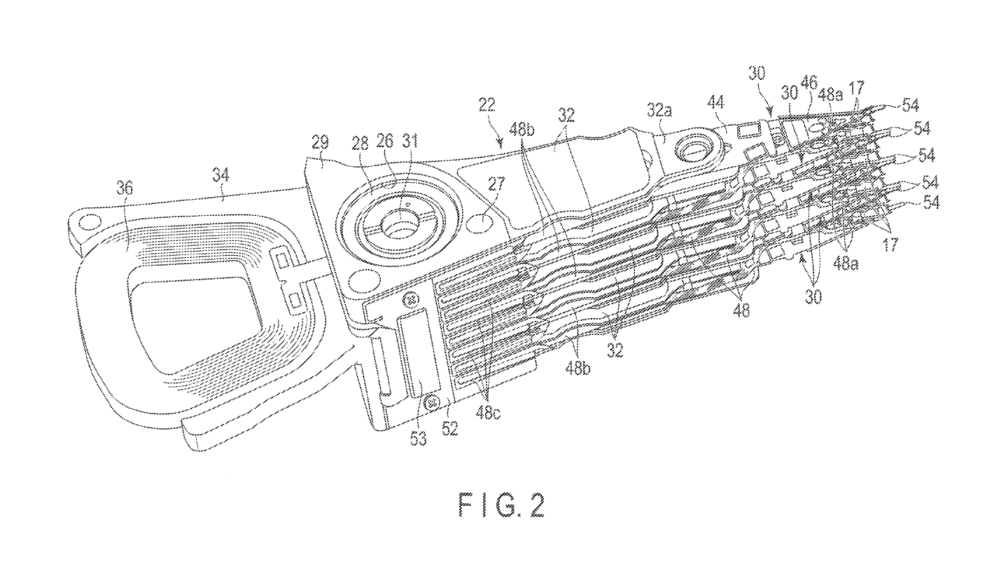

FIG. 2 is a perspective view illustrating the actuator assembly 22. As shown, the actuator assembly 22 comprises an actuator block 29 including a through hole (first hole) 26, a bearing unit (unit bearing) 28 provided within the through hole 26, a plurality of, for example, five arms 32 extending from the actuator block 29, suspension assemblies 30 attached to the respective arms 32, and the magnetic heads 17 supported on the suspension assemblies 30. The actuator block 29 is supported by the bearing unit 28 to be rotatable about a support shaft (axis) 31 standing on the bottom wall 12a. The actuator block 29 includes an insertion hole 27 extending parallel to the supporting shaft 31. The insertion hole 27 is formed to receive a supporting post of a holder fixture 80 to be inserted therein, which will be described later.

In this embodiment, the actuator block 29 and the five arms 32 are formed integrally from aluminum or the like, and constitute a so-called E-block. The arms 32 are formed into, for example, narrow flat plate shapes, and extend from the actuator block 29 in a direction perpendicular to the support shaft 31. The five arms 32 are provided parallel to one another with intervals respectively therebetween.

The actuator assembly 22 includes a support frame 34 extending from the actuator block 29 in a direction opposite to the arms 32, and a voice coil 36, which is a part of the VCM 24, is supported by the support frame 34. As shown in FIG. 1, the voice coil 36 is located between a pair of yokes 38, one of which is fixed on the base 12, and constitutes the VCM 24 together with these yokes 38 and a magnet fixed to one of the yokes.

As shown in FIG. 2, the actuator assembly 22 includes eight suspension assemblies 30 respectively supporting the magnetic heads 17, and these suspension assemblies 30 are attached to distal ends 32a of the respective arms 32. The suspension assemblies 30 include uphead suspension assemblies configured to support the magnetic heads 17 upward and downhead suspension assemblies configured to support the magnetic heads 17 downward. These uphead suspension assemblies and the downhead suspension assemblies are configured by arranging the suspension assemblies 30 having an identical structure with their upper and lower orientations reversed.

In the present embodiment, in FIG. 2, a downhead suspension assembly 30 is attached to the uppermost arm 32, and an uphead suspension assembly 30 is attached to the lowermost arm 32. On each of the three arms 32 in between, an uphead suspension assembly 30 and a downhead suspension assembly 30 are attached thereto.

Each suspension assembly 30 comprises a substantially rectangular base plate 44, a load beam 46 of an elongated leaf spring and an elongated band-shaped flexure (wiring member) 48. A proximal end portion of the base plate 44 is fixed to the extending distal end 32a of the respective arm 32 by, for example, caulking. The load beam 46 comprises its proximal end portion overlapped and fixed to an end portion of the base plate 44. The load beam 46 extends from the base plate 44 and is formed to become narrower toward its extending end. The base plate 44 and the load beam 46 are formed from, for example, stainless steel.

The load beam 46 produces a spring force (reaction force) which urges the magnetic head 17 towards the surface of the magnetic disk 18. Further, a tab 54 projects out from, the distal end of the load beam 46. The tab 54 is engageable with a ramp, which will be described later, and constitutes a ramp load mechanism 25 together with the ramp.

The flexure 48 includes a metal plate of stainless steel or the like, to serve as a base, an insulating layer formed on the metal plate, a conductive layer which constitutes a plurality of wiring lines (of a wiring pattern) formed on the insulating layer, and a protective layer which covers the conductive layer and is formed into a slender belt-like multilayered plate.

The flexure 48 includes a distal end part 48a attached on the surfaces of the load beam 46 and the base plate 44, and a proximal end part 48b extending outward from a side edge of the base plate 44 and further extending to the proximal end portion (actuator block 29) of the arm 32 along the side edge and the arm 32 of the base plate 44. The distal end side part 48a of the flexure 48 is provided with a displaceable gimbal portion (elastic support), and the magnetic head 17 is mounted on the gimbal portion. The wiring lines of the flexure 48 are electrically connected to the magnetic head 17.

A connection end portion 48c is formed in one end of the proximal end portion 48b of the flexure 48. The connection end 48c is formed into a slender rectangular shape. A junction (a rectangular circuit board) 52 of the FPC unit 21 is fixed to a side surface (installation surface) of the actuator block 29. The connection end 48c of the flexure 48 is joined onto the junction 52 to be electrically and mechanically connected thereto. A semiconductor device 53 which constitutes a head IC is mounted on the junction 52.

As shown in FIG. 1, in the state where the actuator assembly 22 is incorporated on the base 12, the support shaft 31 is provided to stand substantially parallel to the spindle of the spindle motor 19. Each magnetic disk 18 is located between a respective pair of two suspension assemblies 30. When the HDD is driven, the magnetic heads 17 attached to the suspension assemblies 30 opposes the upper surface and the lower surface of each of the magnetic disks 18, respectively. The base portion 58 of the FPC unit 21 is fixed to the bottom wall 12a of the base 12. The base portion 58 is connected to the junction 52 described above via a relay FPC.

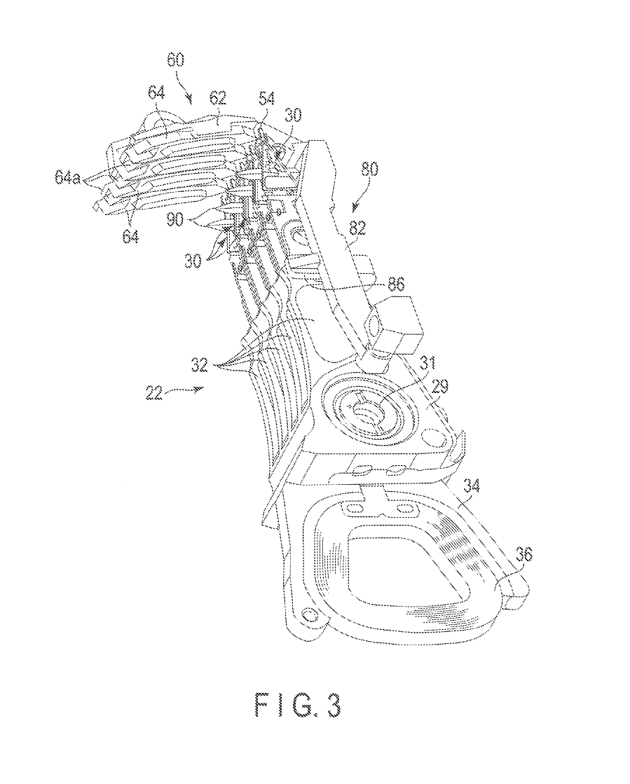

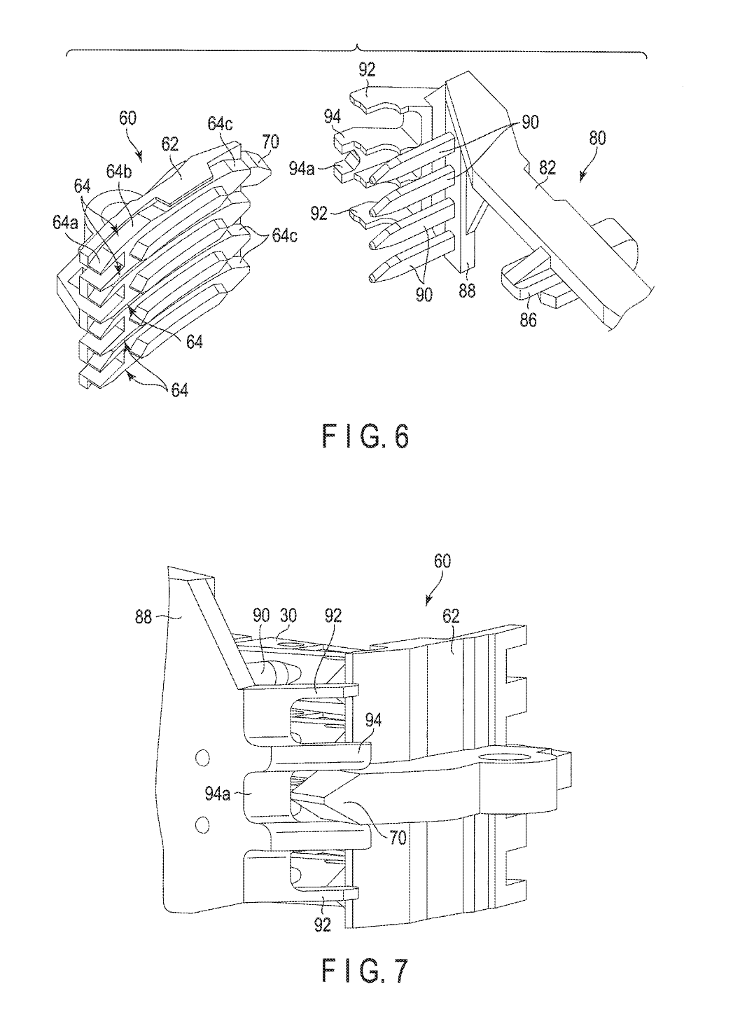

FIG. 3 is a perspective view showing the ramp load mechanism 25 and the actuator assembly 22, and FIG. 6 is a perspective view showing the ramp and the distal end portion of the holder fixture. As shown in FIGS. 1 and 3, the ramp load mechanism 25 comprises a ramp 60. The ramp 60 is fixed to the bottom wall 12a of the base 12 and located near the periphery of the magnetic disks 18. While the HDD is not in operation, if the magnetic head 17 moves off from the outer circumference of the respective magnetic disk 18 to a predetermined stop position, the tab 54 of the suspension assembly 30 rides on the ramp 60. Consequently, the magnetic head 17 can be held in the position spaced off from the respective magnetic disk 18.

As shown in FIGS. 3 and 6, the ramp 60 comprises a ramp body 62 formed into a block shape. On one side portion of the ramp body 62, eight guide surfaces (guide portions) 64 are formed to guide the tabs 54 of the eight suspension assemblies 30, respectively. These guide surfaces 64 are arranged in the axial direction of the magnetic disks 18 at predetermined intervals, and are disposed according to heights of the corresponding suspension assemblies 30, respectively. The guide surfaces 64 each extend substantially along a radial direction of the respective magnetic disk 18 to near the outer circumferential edge thereof, and are disposed on the moving paths of the respective tabs 54. Each guide surface 64 comprises a first slope 64a inclined toward the respective magnetic disk 18 and configured to load and unload the respective magnetic head 17 on the magnetic disk, a flat surface 64b continuous from the first slope 64a and extending parallel to the surface of the respective magnetic disk, and a second slope 64c extending from the other end of the flat surface 64b to the ending edge of the guide surface while inclined.

According to this embodiment, the ramp 60 comprises a positioning projection (first positioning portion) 70 projecting from the ramp body 62. The positioning projection 70 projects from one end (opposite to the magnetic disk 18) of the ramp body 62 in a direction opposite to the magnetic disk 18. A distal end portion of the positioning projection 70 is formed into a tapered shape or to narrow down towards the end. The positioning projection 70 is disposed and formed so as to be engageable with a second positioning portion of the holder fixture 80, which will be described later. When the positioning projection 70 is engaged with the second positioning portion, the holder fixture 80 is positioned at a predetermined position with respect to the ramp 60.

According to the HDD configured as described above, the actuator assembly 22 is pivotally rotated around the support shaft 31 by the VCM 24, and thus the magnetic heads 17 are moved to a desired seek position while facing the surfaces of the respective magnetic disks 18. While the HDD is not in operation, if the magnetic head 17 moves off from the outer circumference of the respective magnetic disk 18 to a predetermined stop position, the tab 54 of the respective one of the, suspension assemblies 30 rides on the respective corresponding guide side surface 64 of the ramp 60. Thus, the magnetic heads 17 can be held at the positions spaced off from the respective magnetic disks 18.

Next, a method of assembling the HDD described above, and here the assembling method of incorporating the actuator assembly 22 to a predetermined position will be described.

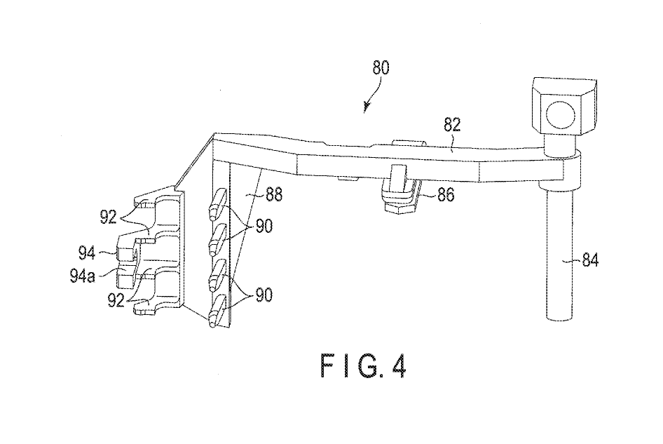

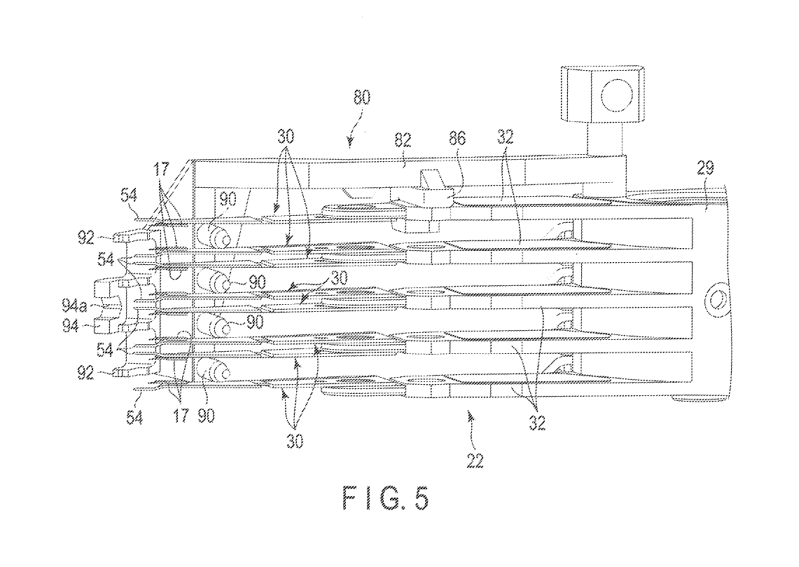

FIG. 4 is a perspective view showing a holder fixture used in the assembling. FIG. 5 is a perspective view showing a state where the holder fixture is fitted to the actuator assembly. FIG. 6 is a perspective view showing the distal end portion of the holder fixture and the ramp.

As shown in FIG. 4, the holder fixture 80 is configured as the so-called clip. The holder fixture 80 comprises a slender plate-shaped main beam 82, a support post 84 extending perpendicular from one end of the main beam 82, a cramp portion 86 in a middle of the main beam 82, and a support bracket 88 extending perpendicular from the other end of the main beam 82, which are formed integrally as one body from a synthetic resin. The support post 84 and the support bracket 88 extend substantially parallel to each other.

As shown in FIGS. 4 and 6, the holder fixture 80 comprises four pressure pins 90 projecting from the support bracket 88. The pressure pins 90 are each provided to project perpendicular with respect to the support bracket 88. The four pressure pins 90 are arranged at predetermined intervals therebetween in a vertical direction. The distal end of each pressure pin 90 is formed into a tapered shape.

The holder fixture 80 further comprises four stopper projections 92 and a forked positioning projection 94, which are provided on the support bracket 88. The forked positioning projection 94 serves as the second positioning portion. The stopper projections 92 are each provided to project perpendicular with respect to the support bracket 88. The four stopper projections 92 are arranged at predetermined intervals in a vertical direction. The four stopper projections 92 are disposed respectively at the same height positions as those of the four pressure pins 90. The stopper projections 92 are each formed abuttable to a rear end edge of the ramp body 62 (which is an edge opposite to the magnetic disk 18).

The positioning projection 94 is provided alongside the two stopper projections 92 at the central portion, so as to project substantially perpendicular to the support bracket 88. The positioning projection 94 comprises an engaging recess 94a located between two projections. The engaging recess 94a is formed at such a position and into such a shape as to be engageable with the positioning projection 70 of the ramp 60.

In the assembly, first, the holder fixture 80 is mounted on the actuator assembly 22 installed pivotably on the bottom wall 12a. As shown in FIGS. 3 and 5, the holder fixture 80 is fitted to the actuator assembly 22 by inserting the support post 84 to the insertion hole 27 of the actuator block 29 from above, and pivotally rotating the holder fixture 80 around the support post 84 toward the actuator assembly 22 to cramping the uppermost arm 32 with the cramp portion 86. During this step, the four pressure pins 90 are inserted between respective adjacent pairs of suspension assemblies 30 in a vertical direction. Each pressure pin 90 expands the respective pair of suspension assemblies 30 to hold them in the state where they oppose each other with a predetermined gap therebetween.

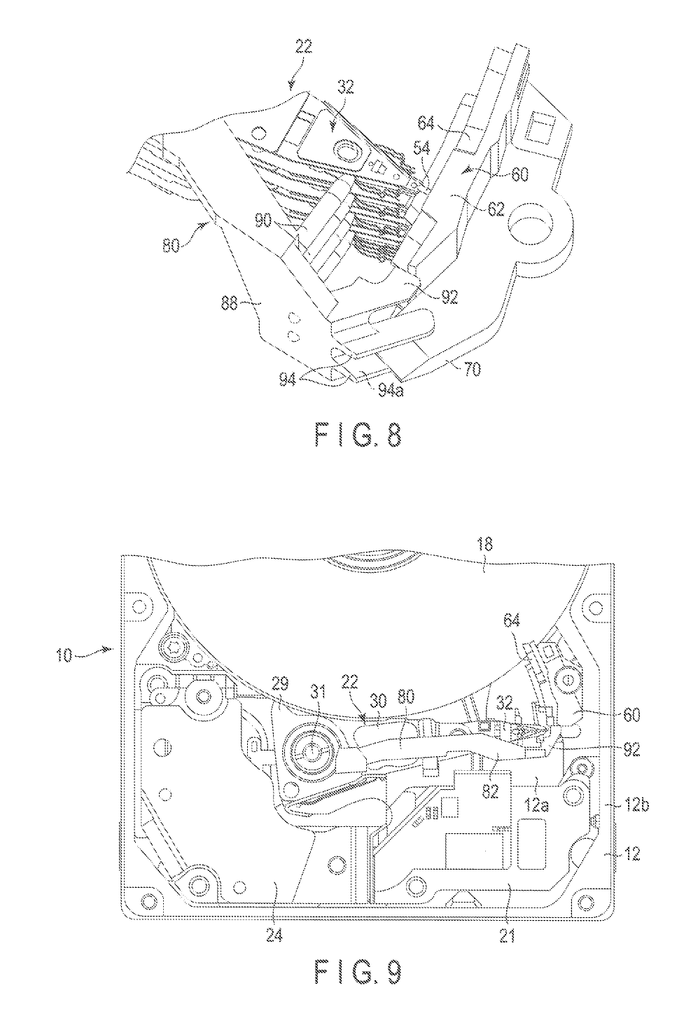

Subsequently, the actuator assembly 22 fitted with the holder fixture 80 is pivotally rotated around the support shaft 31 to a respective magnetic disk 18 side. As shown in FIGS. 3 and 9, the actuator assembly 22 and the holder fixture 80 are rotated until the stopper projections 92 of the holder fixture 80 abut to the end edge of the ramp 60. During this operation, as shown in FIGS. 7 and 8, the positioning projection 94 of the holder fixture 80 is engaged with the positioning projection 70 of the ramp 60. That is, the positioning projection 70 is fit into the engagement recess 94a of the positioning projection 94 so that the positioning projection 94 holds the positioning projection 70 from upper and lower sides. When the positioning projections 70 and 94 are engaged with each other, the holder fixture 80 is positioned at a predetermined position with respect to the ramp 60 in the vertical direction. Accordingly, the suspension assemblies 30, the magnetic heads 17 and the tabs 54 of the actuator assembly 22 are positioned at respective predetermined positions with regard to the guide surfaces 64 of the ramp 60.

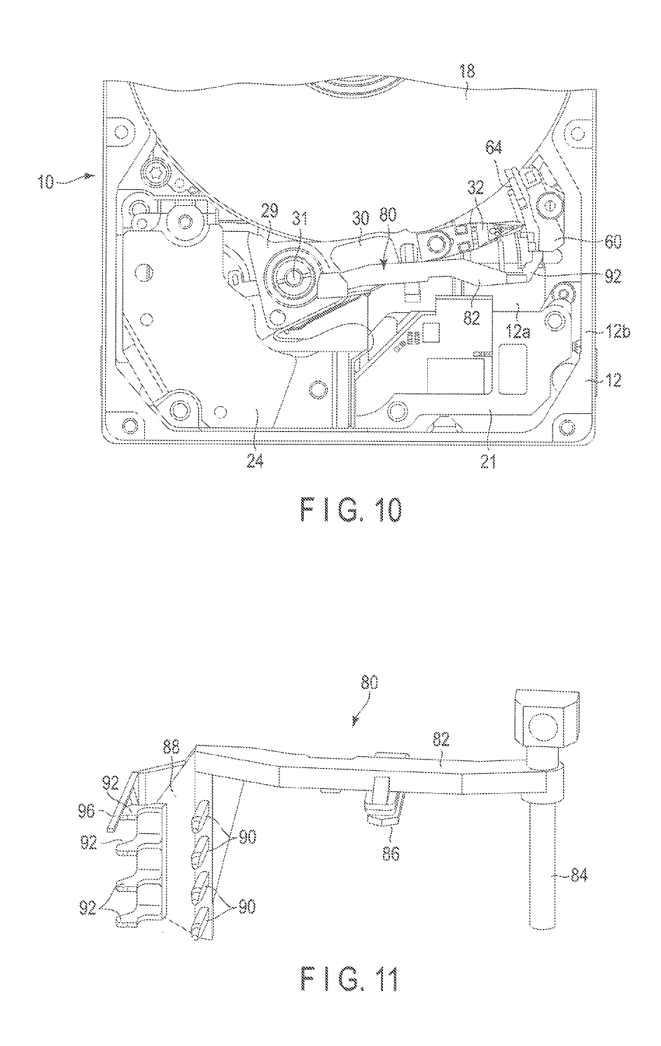

Next, as shown in FIGS. 8 and 10, the actuator assembly 22 is rotated around the support shaft 31 to the respective magnetic disk 18 side so as to insert the tabs 54 into the ramp 60 and to move them onto the corresponding guide surfaces 64, respectively. Here, since the suspension assemblies 30 are positioned at the predetermined positions with respect to the ramp 60, the tabs 54 are moved smoothly onto the guide surfaces 64, respectively, without bumping on the side edges of the ramp body 62 or the like.

Thus, the actuator assembly 22 is installed at the predetermined stop position to be engaged with the ramp 60. Then, the holder fixture 80 is rotated around the support post 84 in a direction away from the respective magnetic disk 18 to extract the cramp portion 86 from the arms 32 and further extract the support post 84 from the actuator block 29, and thus the holder fixture 80 is removed from the actuator assembly 22. In this manner, the operation of assembling the actuator assembly 22 is completed.

According to the HDD and the assembling method thereof, configured as described above, the positioning projection 70 to be engaged with the positioning projection 94 of the holder fixture 80 is provided in the ramp 60, and during the assembling, the positioning projection 94 and the positioning projection 70 are engaged with each other. In this manner, the magnetic heads 17 and the tabs 54 can be positions at the predetermined positions with respect to the ramp 60. Thus, the displacement of the magnetic heads 17 and the tabs 54 with respect to the ramp 60 can be avoided, thereby making it possible to place the tabs 54 and the magnetic heads 17 easily and accurately on the respective guide side surfaces 64 of the ramp 60. As a result, head insertion errors, deformation of the actuator assembly, and the like, which may occur during the assembly, can be prevented, thereby making it possible to improve the efficiency in the manufacture, and reduce the manufacturing cost.

As described above, according to this embodiment, there can be obtained a disk device and a method of assembling the same, which can mount magnetic heads easily and accurately.

Now, an HDD of another embodiment will be described. In the following explanation of the another embodiment, those portions that are the same as those of the first embodiment will be given the same reference numbers and their detailed explanation will be omitted. Only those portions that are different from the first embodiment will be mainly explained in detail.

### Second Embodiment

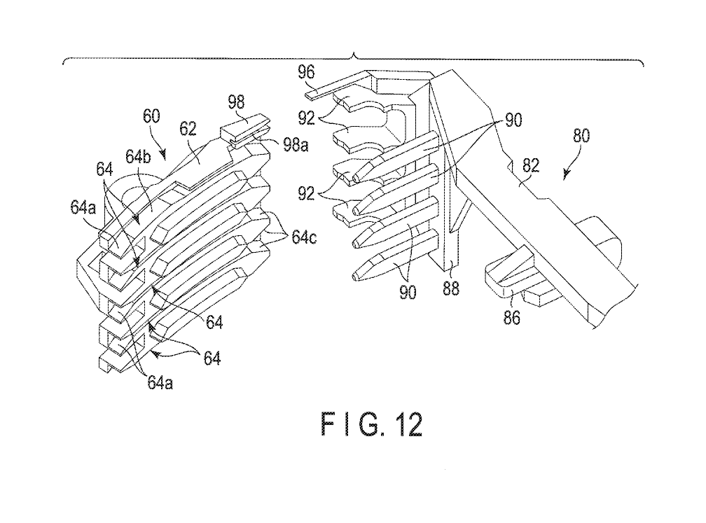

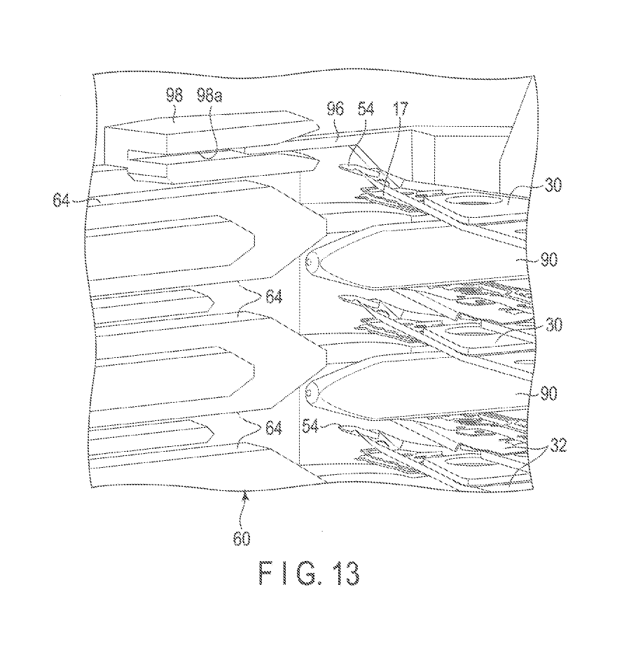

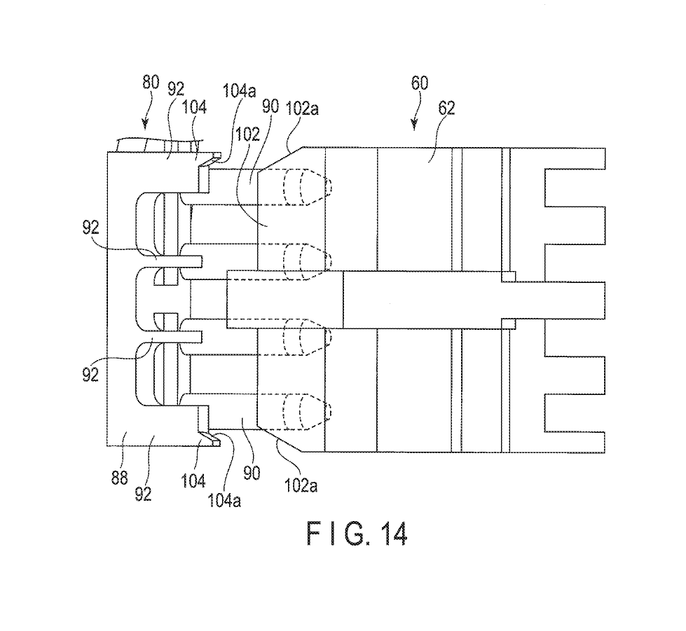

FIG. 11 is a perspective view showing a holder fixture used for assembling an HDD according to the second embodiment. FIG. 12 is a perspective view showing a ramp of the HDD and an engagement portion of a holder fixture, and FIG. 13 is an enlarged perspective view showing the ramp and the positioning engagement portion of the holder fixture.

As shown in FIGS. 12 and 13, in the second embodiment, a ramp 60 comprises a positioning projection 98 provided on an upper portion of a ramp body 62, and an engagement groove 98a or a slit is formed in the positioning projection 98. The engagement groove 98a extends in a direction parallel to the surface of a magnetic disk 18 and it opens to a front surface and a rear end surface of the positioning projection 98. An end portion of the engagement groove 98a on a rear end-surface side is formed into a tapered shape which increases its width gradually.

As shown in FIGS. 11 and 12, the holder fixture 80 comprises a positioning projection 96 which can be inserted to the engagement groove 98a. The positioning projection 96 is formed into a slender plate which extends substantially perpendicular from the support bracket 88 of the holder fixture 80. Moreover, the positioning projection 96 is formed at a height position corresponding to the positioning projection 98 of the ramp 60. The other structure of the holder fixture 80 is identical to that of the holder fixture 80 in the first embodiment described above.

As shown in FIG. 13, during the assembly of the HDD, when the holder fixture 80 fitted to the actuator assembly 22 is pivotally rotated to a position where it abuts on a rear end edge of the ramp 60, the positioning projection 98 is inserted into the engagement groove 98a of the positioning projection 98 of the ramp 60 so as to be positioned in the state where it is sandwiched by the positioning projection 98 from the upper and lower sides. Thus, the holder fixture 80 is positioned at a predetermined position with respect to the ramp 60, and at the same time, magnetic heads 17 and tabs 54 of the actuator assembly 22 are positioned at predetermined positions with respect to the ramp 60. Then, while maintaining this state, the actuator assembly 22 is pivotally rotated onto a magnetic disk side, and thus the magnetic heads 17 and the tabs 54 are inserted to predetermined positions of the ramp 60 to be engaged with guide surfaces 64.

In the second embodiment, the other structures of the HDD are identical to those of the HDD according to the first embodiment described above.

In the second embodiment configured as described above, head insertion errors, deformation of the actuator assembly, and the like, which may occur during the assembly, can be prevented, thereby making it possible to improve the efficiency in the manufacture, and reduce the manufacturing cost. Thus, a disk device which can mount magnetic heads easily and accurately and an assembling method can be obtained.

### Third Embodiment

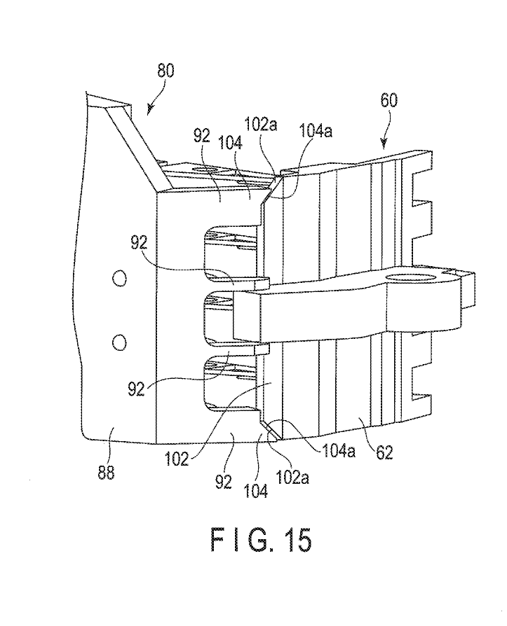

FIG. 14 is a side view showing a distal end portion of a holder fixture used for assembling an HDD, and a rear surface of a ramp according to the third embodiment. FIG. 15 is perspective view showing a state where the ramp and a positioning engagement portion of the holder fixture are engaged with each other.

As shown in FIGS. 14 and 15, according to the third embodiment, an entire rear end edge of the ramp body 62 (which is on an opposite side to the magnetic disk 18) forms the positioning projection 102. Corner portions of upper and lower ends of the positioning projection 102 are cut obliquely, to forms tapered surfaces 102a, respectively.

On the other hand, the positioning fixture 80 comprises four stopper projections 92 projecting from a support bracket 88. The four stopper projections 92 are arranged at predetermined terminals respectively therebetween in a vertical direction. The stopper projections 92 are each formed to be abuttable to a rear end edge of the ramp body 62 (which is on an opposite side to magnetic disks 18). In this embodiment, of the stopper projections 92, two stopper projections 92 at upper and lower ends each comprises a positioning projection 104 projecting from a distal end portion. Each of the positioning projections 104 comprises a slope 104a. The two positioning projections 104 are formed and arranged so as to be engageable with the positioning projections 102 of the ramp 60 and the tapered surfaces 102a, respectively.

As shown in FIG. 15, during the assembly of the HDD, when the holder fixture 80 mounted on the actuator assembly is pivotally rotated to a position where it abuts on the rear end edge of the ramp 60, the two positioning projections 104 are engaged with upper and lower end portions of the respective positioning projection 102 of the ramp 60, to be positioned in the state where the positioning projections 102 are sandwiched from upper and lower sides. Thus, the holder fixture 80 is positioned at a predetermined position with respect to the ramp 60, and at the same time, the magnetic heads and the tabs of the actuator assembly are positioned at predetermined positions with respect to the ramp 60.

In the third embodiment, the other structures of the HDD and the holder fixture are identical to those of the HDD of the first embodiment described above.

### Fourth Embodiment

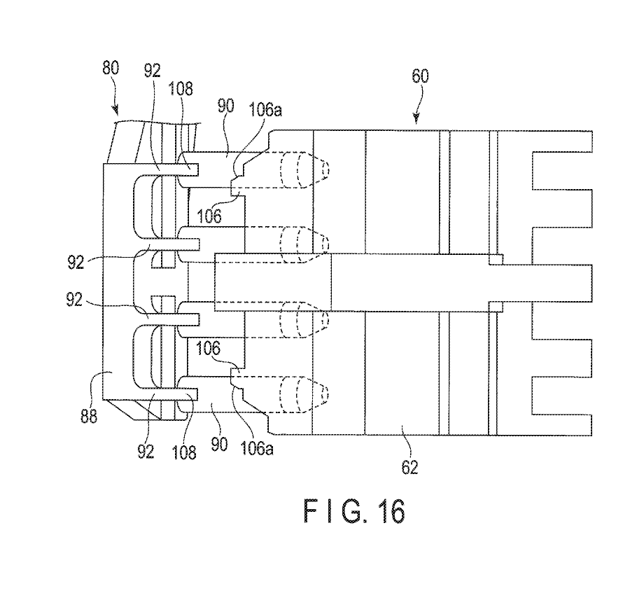

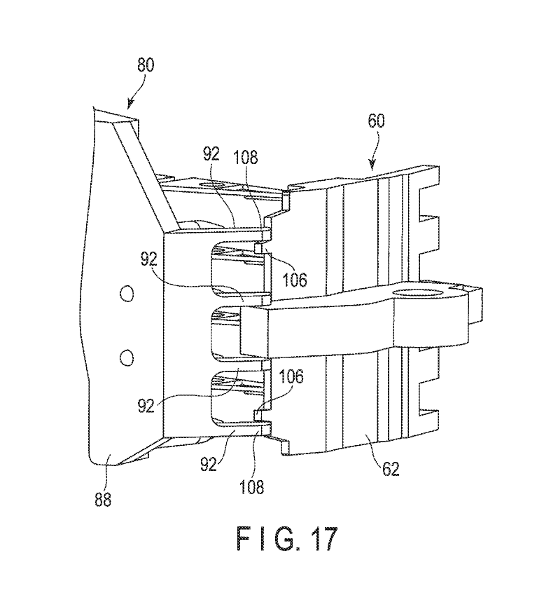

FIG. 16 is a side view showing a distal end portion of a holder fixture used for assembling an HDD, and a rear surface of a ramp according to the third embodiment. FIG. 17 is perspective view showing a state where the ramp and a positioning engagement portion of the holder fixture are engaged with each other.

As shown in FIGS. 16 and 17, according to the fourth embodiment, a ramp 60 comprises a pair of positioning projections 106 projecting from a rear end edge of the ramp body 62 (which is on opposite side to a magnetic disk 18). The positioning projections 106 are provided to be apart from each other in a vertical direction. Each of the positioning projection 106 comprises a slope (tapered surface) 106a.

On the other hand, the positioning fixture 80 comprises four stopper projections 92 projecting from the support bracket 88. The stopper projections 92 are arranged at predetermined terminals respectively therebetween in a vertical direction. Each stopper projection 92 is formed to be abuttable to the rear end edge of the ramp body 62. In this embodiment, of the stopper projections 92, two stopper projections 92 at upper and lower ends are formed and arranged so as to be engageable with the positioning projections 106 and the slopes 106a of the ramp 60, thus each constituting a positioning projection 108.

As shown in FIG. 17, during the assembly of the HDD, when the holder fixture 80 mounted to the actuator assembly is pivotally rotated to a position where it abuts on the rear end edge of the ramp 60, the two positioning projections 108 are engaged with the positioning projection 106 and the slope 106a of the ramp 60 and are positioned in the state where a pair of positioning projections 106 are sandwiched from the upper and lower sides. Thus, the holder fixture 80 is positioned at a predetermined position with respect to the ramp 60, and at the same time, the magnetic heads and tabs of the actuator assembly are positioned at respective predetermined positions with respect to the ramp 60.

In the fourth embodiment, the other structures of the HDD and holder fixtures are identical to those of the HDD according to the first embodiment described above.

In the third and fourth embodiments configured as described above, head insertion errors and deformation of the actuator assembly, which may occur during the assembly can be prevented, thereby making it possible to improve the efficiency in the manufacture and reduce the manufacturing cost. Thus, a device which can easily and accurately mount the magnetic heads to the ramp, and its assembling method can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the shape of the positioning portions of the ramp and the combination with the positioning portion of the holder fixtures are not limited to those of the embodiment mentioned above, but various shapes and combinations can be selected. The number of magnetic disks is not limited to 4, but may be 5 or more or 3 or less, in which case, the number of suspension assemblies or magnetic heads may be decreased or increased according to the number of magnetic disks. The magnetic disk can be formed in various other sizes, e.g., may be more than 3.5 inches or less than 3.5 inches.

What is claimed is:

1. A disk device comprising:
a rotatable disk-shaped recording medium;
a plurality of magnetic heads which process data with respect to the recording medium;
a rotatable actuator assembly comprising a plurality of suspension assemblies which support the plurality of magnetic heads, respectively; and
a ramp comprising a plurality of guide portions engageable with the plurality of suspension assemblies, respectively, and a positioning portion which is configured to position the plurality of suspension assemblies with respect to the ramp during assembly.

2. The device of claim 1, wherein
the ramp comprises a ramp body including the plurality of guide portions, and the positioning portion comprises a positioning projection projecting from the ramp body.

3. The device of claim 2, wherein
the positioning projection comprises a tapered surface.

4. The device of claim 1, wherein
the ramp comprises a ramp body including the plurality of guide portions, and the positioning portion comprises a plurality of positioning projections projecting from the ramp body, and tapered surfaces formed in the positioning projections, respectively.

5. The device of claim 1, wherein
the ramp comprises a ramp body comprising the plurality of guide portions, and the positioning portion comprises a positioning projection on the ramp body and an engagement groove formed in the positioning projection.

6. The device of claim 5, wherein
the engagement groove comprises a tapered surface inclined toward an opening.

7. A method of assembling a disk device comprising a rotatable disk-shaped recording medium, a plurality of magnetic heads which process data with respect to the recording medium, a rotatable actuator assembly comprising a plurality of suspension assemblies which support the plurality of magnetic heads, respectively, and a ramp comprising a plurality of guide portions engageable with the suspension assemblies, respectively, and a first positioning portion,
the method comprising:
fitting a holder fixture comprising a second positioning portion engageable with the first positioning portion of the ramp, to the actuator assembly, and holding the suspension assemblies at predetermined positions, respectively, by the holder fixture;
moving the actuator assembly and the holder fixture fitted thereto, to a position where the second positioning portion of the holder fixture engages with the first positioning portion of the ramp, thereby positioning the holder fixture to the ramp, and
rotating, the actuator assembly while the holder flexure is positioned, to move the plurality of suspension assemblies onto the guide portions of the ramp, respectively.
